(19) United States
(12) Patent Application Publication
(10) Pub. No.: US 2018/0291285 A1
(43) Pub. Date: Oct. 11, 2018

(54) Method For Environmentally Acceptable Treatment Of Emulsions In Chemically Enhanced Oil Recovery Operations

(71) Applicant: Clariant International, Ltd., Muttenz 1 (CH)

(72) Inventors: Anton KAISER, The Woodlands, TX (US); Jonathan WYLDE, The Woodlands, TX (US); Alan WHITE, Houston, TX (US)

(73) Assignee: Clariant International, Ltd., Muttenz 1 (CH)

(21) Appl. No.: 15/575,718

(22) PCT Filed: Apr. 22, 2016
(86) PCT No.: PCT/EP2016/059081

§ 371 Date: Nov. 20, 2017

(30) Foreign Application Priority Data
May 22, 2015 (US) 14720437
Jun. 11, 2015 (EP) 15171656.0

(51) Int. Cl. C10G 33/04; B01D 17/04

(52) U.S. Cl. CPC C10G 33/04; B01D 17/047

(57) ABSTRACT

The present invention provides a method of demulsifying an emulsion comprising water and oil, the method comprising adding an effective amount of a composition comprising
a) an esterquat surfactant of the following formula (1)

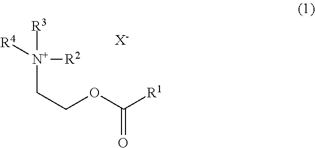

wherein
R¹ is a C₅-C₂₉ aliphatic hydrocarbon group,
R² is —C₂H₄OH or —C₂H₄OCOR¹,
R³ is —C₂H₄OH or —C₂H₄OCOR¹ or a C₁-C₁₀ aliphatic hydrocarbon group
R⁴ is a C₁-C₁₀ aliphatic hydrocarbon group
X is an anion,
b) water, at least one organic solvent or both
to the emulsion.

This invention relates generally to the field of enhanced hydrocarbon production and recovery. More specifically, the invention relates to the field of recovery of crude oil from produced emulsions of polymer enhanced oil recovery floods, surfactant-polymer enhanced oil recovery floods and alkaline-surfactant-polymer enhanced oil recovery floods as well as surfactant enhanced oil recovery floods and alkaline-surfactant enhanced oil recovery floods. The invention has particular relevance to the use of environmentally acceptable surfactants comprising a plurality of hydrophilic groups.

The production of crude oil from reservoirs typically results in significant quantities of non-produced crude oil remaining in the reservoir. After primary oil recovery has been performed, secondary recovery (typically involving water injection), is frequently begun to produce trapped oil. Frequently, much oil remains in the reservoir and tertiary recovery operations have been developed to produce the remaining oil. Most tertiary recovery methods for recovering such remaining crude oil include polymer enhanced oil recovery, surfactant-polymer enhanced oil recovery and alkaline-surfactant-polymer enhanced oil recovery floods, such as injecting combination of alkaline and/or surfactants and/or polymers in brine solutions into the reservoir. Other methods for enhanced oil recovery may include gas injection, chemical injection, ultrasonic stimulation, microbial injection, and thermal recovery. If the oil recovered using enhanced oil recovery floods cannot be efficiently treated (e.g., the emulsion broken into dry oil and clean water), then most if not all oil producers will be reluctant to conduct chemical enhanced oil recovery floods in favor of other less aggressive and lower recovery processes.

Results of conventional tertiary recovery methods involving chemicals include a produced emulsion that typically contains crude oil, water, alkaline, surfactant, and polymer. Drawbacks include difficulties in separating the emulsion into clean water and dry oil for efficient recovery of the crude oil and proper disposal of the water in an environmentally safe manner. Heat has been used to aid in resolving such emulsions but is not economical due to the large amounts of water involved.

Solvent extraction is disclosed in U.S. Pat. No. 4,559,148, but is also not practical due to the large capital investment and flammable solvent handling issues. Consequently, there is a need for improved methods of resolving the crude oil and water emulsions. Additional needs include improved methods for demulsifying the produced emulsion to produce a clean separation of the crude oil and water.

US-20110247966 discloses a method for treatment of emulsions in enhanced oil recovery operations by the use of quarternary alkyl amines. These amines are very toxic to the effected environment, especially highly aqua-toxic, which makes their actual use for emulsion treatment in oil production operations almost impossible. Additionally, these compounds show negative effects in terms of Water in Oil emulsion resolution which makes the use of these products non-economical.

EP-A-2497844 teaches a composition that is suitable for use as a corrosion inhibitor to prevent corrosion, particularly on metallic devices for the recovery and transportation of hydrocarbons in oil production and processing. In particular, the present invention relates to quaternary ammonium compositions found to be effective corrosion inhibitors. The invention also concerns methods of preparation and use of the compositions and methods for inhibiting or preventing the corrosion of metal surfaces using said compositions, particularly in oil and gas field applications.

US-2005/0189113 teaches acidic treatment fluids that comprise an acid fluid and an ester-containing quaternary ammonium compound (“esterquat”) and methods of their use. One embodiment of the present invention provides a method of inhibiting metal corrosion during a subterranean treatment operation comprising using an acidic treatment fluid comprising an acidic fluid and an esterquat. Another embodiment of the present invention provides a method of reducing sludge formation during a subterranean treatment operation formation comprising the step of using an acidic treatment fluid comprising an acidic fluid and an esterquat. Another embodiment of the present invention provides a method of inhibiting the formation of emulsions during a subterranean treatment operation comprising using an acidic treatment fluid comprising an acidic fluid and an esterquat. Another embodiment of the present invention provides an acidic subterranean treatment fluid comprising an acidic fluid and an esterquat.

In the prior art there is yet no widely accepted and economically viable way of breaking emulsions produced from oil wells using tertiary oil recovery techniques that involve chemicals. The problem to be solved by the instant invention was to provide a method suitable to break such emulsions.

Surprisingly, it has been found that environmentally acceptable esterquat surfactants are suitable to break such emulsions. Accordingly, the present invention provides a method for resolving emulsions produced through an enhanced oil recovery process, the method including adding a composition comprising at least one esterquat surfactant.

In a first aspect, the invention provides a method of demulsifying an emulsion comprising water and oil, the method comprising adding a composition comprising
a) an esterquat surfactant of formula (1)

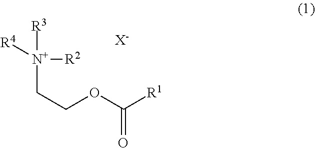

wherein
R¹ is a C₅-C₂₉ aliphatic hydrocarbon group,
R² is —C₂H₄OH or —C₂H₄OCOR¹,
R³ is —C₂H₄OH or —C₂H₄OCOR¹ or a C₁-C₁₀ aliphatic hydrocarbon group
R⁴ is a C₁-C₁₀ aliphatic hydrocarbon group
X is an anion, as methylsulfate, bromide, iodide, fluoride, and preferably chloride,
b) water, at least one organic solvent or both,
to the emulsion.

In a second aspect, this invention provides for the use of a composition comprising
a) an esterquat surfactant of the following formula (1)

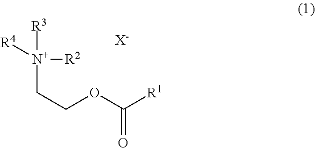

wherein
R¹ is a C₅-C₂₉ aliphatic hydrocarbon group,
R² is —C₂H₄OH or —C₂H₄OCOR¹,
R³ is —C₂H₄OH or —C₂H₄OCOR¹ or a C₁-C₁₀ aliphatic hydrocarbon group
R⁴ is a C₁-C₁₀ aliphatic hydrocarbon group
X is an anion,
b) water, at least one organic solvent, or both
as demulsifier for emulsions comprising water and oil.
R¹ preferably is a C₇ to C₂₃, more preferably C₉ to C₂₁ hydrocarbon group. In a preferred embodiment R¹ is an alkyl group or an alkenyl group.
R² preferably is —C₂H₄OH.
R³ and R⁴ are preferably C₁ to C₄ hydrocarbons, more preferably methyl.

In one more preferred embodiment, one of R² and R³ is —C₂H₄OH and R⁴ is a C₁ to C₄ hydrocarbon, still more preferably methyl.

The group —OCOR¹ is preferably derived from naturally occurring fatty acids such as capronic acid, caprylic acid, caprinic acid, lauric acid, myristiric acid, palmic acid, isostearic acid, stearic, oleic acid, eluidinic acid, arachinic acid, behenic acid and eruca acid. Preferred acids containing the group —OCOR¹ are C₁₂/C₁₈ coco fatty acids, tallow fatty acid, fully or partially hydrogenated tallow fatty acid, palm fatty acid, partially or fully hydrogenated palm fatty acid or stearic acid.

Preferably the fatty acid is derived from vegetable and/or animal fatty acid and contains at least 50 by weight of saturated fatty C₁₈-acid, more preferably from 52 to 90% by weight of saturated C₁₈-fatty acid and even more preferably from 55 to 85% by weight of saturated C₁₈-fatty acid. The most preferential molar relationship in the esterification between alkyl(di)ethanolamine and fatty acid is for example that the reaction product comprises at least 50 mol-% diester quat and at least 10 mol-% monoesterquat.

The esterquat surfactants of formula (1) are preferably environmentally acceptable compounds. esterquat surfactants of formula (1) having at least one alkanol residue like Mono- and Dialkyldialkanolamine esterquat surfactants are quarternary amine surfactants which are environmentally widely acceptable in terms of aquatoxicity and biodegradation. In this invention, esterquat surfactants of formula (1) having at least one alkanol residue are preferred. The aforementioned preferred quarternary esterquats correspond to the formula (1) wherein at least one of R² and R³ is —C₂H₄OH. Representative Dialkyldialkanolamine esterquat surfactants of formula (1) include dimethyldiethanolamine fatty acid esterquats.

This invention comprises a method of treating an emulsion comprising oil and water derived from an oil recovery process. The emulsions are preferably produced through an enhanced oil recovery process. A preferred area of the method of the invention is emulsions derived from enhanced oil recovery processes where oil remaining in a reservoir after conventional recovery methods have been exhausted is produced through, for example, a polymer-surfactant flood. It should, however, be appreciated that the method of the invention has equal application to emulsions derived from any conventional or enhanced oil recovery operation. The objective of the present invention is to provide a method of resolving emulsions resulting in dry oil and clean water.

The emulsion produced from a tertiary or enhanced oil recovery process is typically stabilized with surfactants and polymers. The method of the invention is applicable to any enhanced or tertiary oil recovery process. Exemplary methods of producing oil through such enhanced oil recovery processes are disclosed in U.S. Pat. No. 4,293,428 and U.S. Pat. No. 4,018,278. In the method of the invention, emulsions are treated by any combination of surfactants having a plurality of hydrophilic groups. Preferred surfactants comprise environmentally acceptable quaternary amine surfactants to demulsify emulsions produced, for example, by surfactant-polymer enhanced oil recovery floods or polymer floods and recover dry oil and clean water. In such embodiments, the produced emulsions typically contain at least water, crude oil, surfactants, and/or polymers. Addition of the composition to the produced emulsion separates the oil and water phases. In some embodiments, the separation is a clean separation of oil and water. A clean separation generally refers to dry oil with less than about 0.5% total sediment and water, a good interface with sharp separation between oil and water, and clean water with less than about 200 parts per million (ppm) residual oil. The composition is added to the emulsion by any suitable method. Suitable methods are described in Z. Ruiquan et al., “Characterization and demulsiflcation of produced liquid from weak base ASP flooding,” Colloids and Surfaces, Vol. 290, pgs 164-171, (2006); U.S. Pat. No. 4,374,734 and U.S. Pat. No. 4,444,654.

In contrast to conventional surfactants that generally have one hydrophilic group and one hydrophobic group, esterquat surfactants according to formula 1 have one, two or more hydrophilic groups. Such esterquat surfactants are typically about 10 to about 1,000 times more surface active than conventional surfactants with similar but single hydrophilic and hydrophobic groups in the molecule. These esterquat surfactants also have remarkably low critical micelle concentration (CMC) values compared to the corresponding conventional surfactants of equivalent chain length.

These esterquat surfactants are made by methods known per se, for example by esterification of alkyldiethanolamine or dialkylmonoethanolamine, e.g. methyl-diethanolamine, with a fatty acid of the formula R¹—COOH and subsequent quaternization, preferably with an alkyl chloride, more preferably with methylchloride or dimethylsulfate or any other quaternization agent introducing a methyl group.

The composition comprising a) and b) may contain any desirable amount of the esterquat surfactant of formula (1). In a preferred embodiment, the esterquat surfactant of formula (1) is present in the composition comprising a) and b) in an amount from about 20 wt % to about 90 wt %, more preferably from about 25 wt % to about 70 wt %, and still more preferably from about 30 wt % to about 60 wt %.

The esterquat surfactants of formula (1) may be delivered as a composition having said surfactant and a solvent. The solvent may be any solvent suitable, for example, for dissolving or suspending said surfactant. In preferred embodiments, the solvent is water, alcohol, an organic solvent, or any combination thereof. The alcohol may include any alcohol suitable as a solvent and for use with oil recovery operations. Without limitation, examples of suitable alcohols include ethylene glycol, propylene glycol, butylene glycol, oligoethylene glycols, oligopropylene glycols, isopropyl alcohol, methanol, ethanol, propanol, butanol or any combination thereof. Oligoethylene glycols and oligopropylene glycols preferably have a number average molecular weight between 200 and 1000 g/mol.

According to an embodiment, the organic solvent includes aromatic compounds, either alone or in any combination with the foregoing. In an embodiment, the aromatic compounds have a molecular weight from about 70 to about 400, preferably from about 100 to about 200. Examples of suitable aromatic compounds include toluene, xylene, naphthalene, ethylbenzene, trimethylbenzene, and aromatic naphtha (AN), other suitable aromatic compounds, and any combination of the foregoing. It is to be understood that the amount of esterquat surfactants of formula (1) in the composition in relation to the solvent may vary in some embodiments depending upon factors such as temperature, time, and type of esterquat surfactants of formula (1). For instance, without limitation, a higher ratio of esterquat surfactants of formula (1) to solvent may be used if a faster reaction time is desired.

The surfactant may be added to the emulsion in any suitable amount. A suitable amount means an amount in which the surfactant will break the emulsion. In a preferred embodiment, the surfactant is added to the emulsion in an amount from about 5 ppm to about 20,000 ppm by weight of the compound of formula 1 with respect to the weight of the emulsion. In preferred embodiments, from about 100 ppm to about 10,000 ppm of the surfactant, further preferred from about 200 ppm to about 5,000 ppm surfactant, and further preferred from about 200 ppm to about 500 ppm surfactant is added to the emulsion, based on weight of the compound of formula 1 with respect to the weight of the emulsion.

In preferred embodiments, the esterquat surfactant of formula (1) is used in conjunction with other surfactants or additives. The expression “other surfactants” refers to surfactants which are not esterquat surfactants of formula (1). These other surfactants or additives may be added as part of the composition comprising the esterquat surfactants of formula (1), or as a separate composition, and may be added simultaneously or sequentially. For example, the composition comprising a) and b) may be added to the produced emulsion with a polymeric nonionic other surfactant. Without limitation, examples of suitable polymeric nonionic other surfactants include polysorbates, fatty alcohols such as cetyl alcohol and oleyl alcohol, polymers comprising ethylene oxide, polymers comprising propylene oxide, ethylene oxide-propylene oxide copolymers, alkyl polyglucosides such as decyl maltoside, alkylphenol polyethylene oxide, alkyl polyethylene oxide, and ethoxylated and/or propoxylated alkyl phenol-formaldehyde resins.

The polymeric nonionic other surfactant is preferably dissolved or suspended in a solvent. Any solvent suitable for dissolving or suspending a polymeric nonionic other surfactant may be used. Examples of suitable solvents include water, butylglycol, ethylene glycol, propylene glycol, butylene glycol, oligoethylene glycols, oligopropylene glycols, ethers, alcohols, toluene, xylene, aromatic naphtha, or any combination thereof. The alcohol may include any alcohol suitable for use with oil recovery and for dissolving the polymeric nonionic surfactant and is preferably selected from the group consisting of isopropyl alcohol, methanol, ethanol, propanol, butanol or any combination thereof.

In a preferred embodiment, the esterquat surfactants of formula (1) and a polymeric nonionic other surfactant are added to the produced emulsion in a weight ratio of surfactant to polymeric nonionic other surfactant from about 9:1 to about 1:1. In preferred embodiments, the esterquat surfactants of formula (1) and polymeric nonionic other surfactant are added about simultaneously (either as separate formulations or as part of the same formulation) or sequentially to the produced emulsion. Simultaneous addition to the produced emulsion of the esterquat surfactants of formula (1) and a polymeric nonionic other surfactant generally provides improved quality of separated oil and aqueous phases. For instance, the simultaneous addition to the produced emulsion of the esterquat surfactants of formula (1) and water with a polymeric nonionic other surfactant dissolved in an organic solvent improved the quality of the separated oil and aqueous phases.

The instant invention meets the previously unmet need of efficiently demulsifying an emulsion comprising water and oil, either oil in water and/or water in oil. The emulsions applicable in the method of the invention are preferably derived from an enhanced oil recovery process, though the method has equal applicability to any emulsions encountered in the art.

It is an advantage of the invention to provide a novel method of resolving an emulsion comprising oil and water.

It is another advantage of the invention to provide a novel method of efficiently resolving an emulsion comprising oil and water that was derived from an enhanced oil recovery process.

It is a further advantage of the invention to provide a novel method of resolving an emulsion comprising oil and water utilizing any combination of esterquat surfactants and polymeric surfactants.

It is yet another advantage of the invention to provide a novel method of resolving an emulsion comprising oil and water resulting in dry oil and clean water.

It is a further advantage of the invention to provide a novel method of resolving an emulsion comprising oil and water utilizing environmentally acceptable esterquat surfactants.

It is yet another advantage of the invention to provide a novel method of efficiently resolving a water-in-oil emulsion that was derived from an enhanced oil recovery process.

It is yet another advantage of the invention to provide a novel method of efficiently resolving an oil-in-water emulsion that was derived from an enhanced oil recovery process.

### EXAMPLES

The following two samples of EOR Emulsion Breaker were prepared by using Dioleic acid triethanolamine esterquat wherein R¹ is C₁₇ unsaturated hydrocarbon as occurring in the natural oleic acid, R² is —C₂H₄OCOR¹, R³ is —C₂H₄OH, R⁴ is methyl and X is Cl⁻, blended together with a commercial emulsion breaker blend Phasetreat® 4688 which is a composition including an ethylene oxide/propylene oxide copolymer and an ethoxylated nonylphenol-formaldehyde resin in solvent naphtha. Weight ratios are given in parts of active ingredient.

TABLE 1
EOR demulsifier blends 1 and 2

| | | | Weight Ratio |
|---|---|---|---|
| | | | Esterquat/ |
| Sample | Esterquat | Demulsifier Blend | Demulsifier Blend |
| 1 | Di-oleic acid | PHASETREAT ® 4688 | 5/1 |
| | triethanolamine | | |
| | Esterquat | | |
| 2 | Di-oleic acid | PHASETREAT ® 4688 | 1/1 |
| | triethanolamine | | |
| | Esterquat | | |

Determination of Breaking Efficacy of Petroleum Emulsion Breakers

Emulsion breaker efficacy was determined by determining water separation from a crude-oil emulsion per unit time and by the dewatering of the oil. To this end, breaker glasses (conically tapered, graduated glass bottles closeable with a screw top lid) were each filled with 100 ml of the crude-oil emulsion, a defined amount of the emulsion breaker was in each case added with a micropipette just below the surface of the oil emulsion, and the breaker was mixed into the emulsion by intensive shaking. Thereafter, the breaker glasses were placed in a temperature control bath and water separation was tracked.

On completion of emulsion breaking, samples of the oil were taken from the top part of the breaker glass (top oil). A 15 ml centrifuge vial (graduated) is filled with 5 ml of Shellsol® A 150 ND and 10 ml of oil sample, the vial is shaken by hand to achieve commixing, and is then centrifuged at 1500 rpm for 5 minutes. After centrifuging, three phases are observed in the centrifuge vial: a clear aqueous phase, a brown emulsion phase and a black oily phase. The volumes determined for the aqueous and emulsion phases are multiplied by a factor of 10 and values thus determined are reported as % water and % emulsion. The remainder to 100% is the oily phase. Demulsification is particularly good when the sum total of % water and % emulsion is very small. Comparing two equal sum totals of % water and % emulsion, it is preferable for the % water fraction to be as large as possible. In this way, the novel breakers were assessed in terms of water separation and also oil dewatering. The quality of the water separated off was assessed by a practiced observer:

the entry “+” means that the water separated off is clear

the entry “o” means that the water separated off is cloudy

the entry “−” means that the water separated off is nontransparent owing to oiling.

As can be seen in Table 2, the present invention is very effective at resolving the emulsion. Enhanced oil recovery breakthrough fluid emulsion 1 was a collected form a polymer flood in North America. Enhanced oil recovery breakthrough fluid emulsion 2 was a collected form a alkaline surfactant polymer flood in Middle East.

TABLE 2
Bottle test results of demulsification studies with Polymer
breakthrough fluid 1 and ASP breakthrough fluid 2.

| | EOR | | | | | | | % | | |
|---|---|---|---|---|---|---|---|---|---|---|
| | Breakthrough | Demulsifier Sample | Water separation [ml] | | | | | Water | % | Water |
| Example | Fluid | (Table 1) | 10 min | 20 min | 30 min | 60 min | 120 min | in Oil | Emulsion | Quality |
| 1 | 1 | 1 | 5 | 12 | 35 | 47 | 48 | 0.2 | 0.8 | + |
| 2 | 1 | 2 | 10 | 32 | 40 | 48 | 49 | 0.2 | 0.7 | + |
| 3 | 2 | 1 | 10 | 22 | 45 | 45 | 47 | 0.8 | 1.0 | + |
| 4 | 2 | 2 | 8 | 21 | 38 | 42 | 45 | 0.7 | 1.0 | ∘ |
| 5 (C) | 1 | PHASETREAT ® 4688 | 1 | 5 | 15 | 32 | 45 | 15 | 10 | − |
| 6 (C) | 2 | PHASETREAT ® 4688 | 0 | 1 | 3 | 5 | 5 | 20 | 40 | − |

As mentioned before. The environmental acceptability of these esterquat surfactant compounds is of essential importance for emulsion breaking operations in oil production processes. The environmental properties of Di-oleic acid triethanolamine esterquat is as follows
biodegradation: OECD 306=67% (28 d)
toxicity: skeletonema costatum LC50=7.4 mg/L
bioaccumulation: log Pow=0.73 (slow stirring method) and MW>700 g/mol

1. A method of demulsifying an emulsion comprising water and oil, the method comprising adding a composition comprising
a) an esterquat surfactant of formula (1) 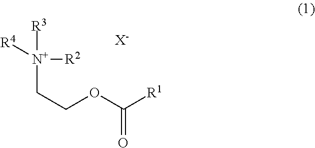
wherein
R¹ is a C₅-C₂₉ aliphatic hydrocarbon group,
R² is —C₂H₄OH or —C₂H₄OCOR¹,
R³ is —C₂H₄OH or —C₂H₄OCOR¹ or a C₁-C₁₀ aliphatic hydrocarbon group
R⁴ is a C₁-C₁₀ aliphatic hydrocarbon group
X is an anion, and
b) water, at least one organic solvent, or both,
to the emulsion.

2. The method according to claim 1, wherein R¹ is C₇ to C₂₁.

3. The method according to claim 1, wherein R¹ is alkyl.

4. The method according to claim 1, wherein R¹ is alkenyl.

5. The method according to claim 1, wherein R³ and R⁴ are C₁ to C₄ hydrocarbons.

6. The method according to claim 5, wherein R³ and R⁴ are methyl.

7. The method according to claim 1, wherein one of R² and R³ is —C₂H₄OH and R⁴ is a C₁ to C₄ hydrocarbon.

8. The method according to claim 7, wherein R⁴ is methyl.

9. The method according to claim 1, wherein the composition comprises from 20 to 90 wt.-% of the compound according to formula (1).

10. The method according to claim 1, wherein 5 to 20,000 ppm by weight of the compound according to formula 1 based on the total weight of the emulsion added to the emulsion.

11. The method according to claim 1, further comprising the step of adding a polymeric nonionic surfactant to the emulsion.

12. The method according to claim 11, wherein the composition and the polymeric nonionic surfactant are added to the emulsion in a weight ratio of 20:1 to 1:10.

13. The method according to claim 12, wherein the polymeric nonionic surfactant and the composition are added about simultaneously to the emulsion.

14. The method according to claim 1, wherein the emulsion is a crude oil obtained from an enhanced oil recovery operation.

15. A demulsifier composition comprising
a) an esterquat surfactant of the following formula (1) 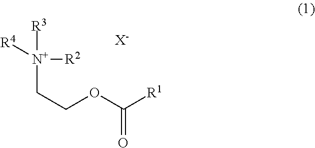
wherein
R¹ is a C₅-C₂₉ aliphatic hydrocarbon group,
R² is —C₂H₄OH or —C₂H₄OCOR¹,
R³ is —C₂H₄OH or —C₂H₄OCOR¹ or a C₁-C₁₀ aliphatic hydrocarbon group
R⁴ is a C₁-C₁₀ aliphatic hydrocarbon group
X is an anion, and
b) water, at least one organic solvent, or both.
